(19) United States
(12) Patent Application Publication
(10) Pub. No.: US 2026/0181489 A1
(43) Pub. Date: Jun. 25, 2026

(54) METHODS, APPARATUSES AND SYSTEMS FOR MEASUREMENT OF APERIODIC REFERENCE SIGNALS

(71) Applicant: InterDigital Patent Holdings, Inc., Wilmington, DE (US)

(72) Inventors: Brian Martin, Farnham (GB); Samuli Turtinen, Ii (FI); Martino Freda, Laval (CA); Oumer Teyeb, Montreal (CA); Paul Marinier, Brossard (CA); Dylan Watts, Montreal (CA); Keiichi Kubota, Setagaya-Ku (JP)

(21) Appl. No.: 18/989,666

(22) Filed: Dec. 20, 2024

(51) Int. Cl. H04W 36/00; H04L 5/00

(52) U.S. Cl. CPC H04W 36/0058; H04L 5/0051; H04W 36/0016

(57) ABSTRACT

Procedures, methods, apparatuses, systems, devices, and computer program products for measurement of aperiodic reference signals. A wireless transmit/receive unit, WTRU, performs measurements of at least one periodic reference signal to obtain first measurement results, upon reception of information indicative of presence of at least one aperiodic reference signal, performs measurements of at least one periodic reference signal and the at least one aperiodic reference signal to obtain second measurement results, and based on the second measurement results and second measurement quality evaluation criteria, performs at least one of preparing for handover or executing handover.

### TECHNICAL FIELD

The present disclosure is generally directed to the fields of communications, software and encoding, including, for example, to methods, apparatuses, systems directed to measurement of aperiodic reference signals.

### SUMMARY

In a first aspect, the present principles are directed to a method at a wireless transmit/receive unit, WTRU, the method including performing measurements of at least one first periodic reference signal to obtain first measurement results, upon reception of information indicative of presence of at least one aperiodic reference signal, performing measurements of at least one second periodic reference signal and the at least one aperiodic reference signal to obtain second measurement results, and based on the second measurement results and second measurement quality evaluation criteria, performing at least one of preparing for handover or executing handover. In embodiments, the at least one first reference signal and at least one second reference signal may include one or more of the same reference signals.

In embodiments, the method further includes, based on the first measurement results and first measurement quality evaluation criteria, transmitting information indicative of a request for at least one of timing information or transmission of the at least one aperiodic reference signal. The WTRU can receive information indicative of a handover configuration for one or more candidate cells, the information indicative of a handover configuration for one or more candidate cells indicating the at least one first periodic reference signal and/or the at least one second periodic reference signal, the at least one aperiodic reference signal, the first measurement quality evaluation criteria and the second measurement quality evaluation criteria.

In embodiments, the information indicative of presence of at least one aperiodic reference signal is received from a cell currently serving the WTRU.

In embodiments, the information indicative of presence of at least one aperiodic reference signal is received from a neighboring cell in a periodic signal.

In embodiments, any of the at least one first periodic reference signal and the at least one second periodic reference signal is transmitted in a cell currently serving the WTRU.

In embodiments, any of the at least one first periodic reference signal and the at least one second periodic reference signal is transmitted in a neighboring cell, the neighboring cell being a neighbor to the cell currently serving the WTRU.

In embodiments, preparing for handover includes sending, to a cell currently serving the WTRU, information indicative of at least one of the first measurement results or the second measurement results.

In a second aspect, the present principles are directed to a wireless transmit/receive unit, WTRU, including at least one processor configured to perform measurements of at least one first periodic reference signal to obtain first measurement results, upon reception of information indicative of presence of at least one aperiodic reference signal, perform measurements of at least one second periodic reference signal and the at least one aperiodic reference signal to obtain second measurement results, and based on the second measurement results and second measurement quality evaluation criteria, perform at least one of preparing for handover or executing handover. In embodiments, the at least one first reference signal and at least one second reference signal may include one or more of the same reference signals.

In embodiments, the at least one processor is further configured to, based on the first measurement results and first measurement quality evaluation criteria, transmit information indicative of a request for at least one of timing information or transmission of the at least one aperiodic reference signal. The at least one processor can be configured to receive information indicative of a handover configuration for one or more candidate cells, the information indicative of a handover configuration for one or more candidate cells indicating the at least one first periodic reference signal and/or the at least one second reference signal, the at least one aperiodic reference signal, the first measurement quality evaluation criteria and the second measurement quality evaluation criteria.

In embodiments, the information indicative of presence of at least one aperiodic reference signal is received from a cell currently serving the WTRU.

In embodiments, the information indicative of presence of at least one aperiodic reference signal is received from a neighboring cell in a periodic signal.

In embodiments, any of the at least one first periodic reference signal and the at least one second reference signal is transmitted in a cell currently serving the WTRU.

In embodiments, any of the at least one first periodic reference signal and the at least one second reference signal is transmitted in a neighboring cell, the neighboring cell being a neighbor to the cell currently serving the WTRU.

In embodiments, prepare for handover includes send, to a cell currently serving the WTRU, information indicative of at least one of the first measurement results or the second measurement results.

In embodiments, execute handover includes execute, based on whether at least one of the first measurement results meet first measurement quality evaluation criteria or the second measurement quality evaluation criteria are met, a first reconfiguration or a second reconfiguration. Each of the first reconfiguration and the second reconfiguration can include SCells, wherein the SCells of the first reconfiguration are different from the SCells of the second reconfiguration. The first reconfiguration can be for a conditional handover.

In embodiments, at least one of information indicative of the at least one first periodic reference signal, information indicative of the at least one second periodic reference signal, information indicative of the at least one aperiodic reference signal, and the information indicative of presence of the at least one aperiodic reference signal is received by the WTRU in a transmission using media access control control element, MAC CE, with index.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates multi-RAT spectrum sharing (MRSS) and gradual migration of the spectrum from fifth generation (5G) to sixth generation (6G);

FIG. 3 illustrates a possible solution for dual 5G/6G connectivity;

FIG. 4 illustrates 6G as a standalone system, with MRSS for already deployed 5G bands; and

FIG. 5 illustrates a method for triggering of aperiodic RRM measurement of LTM neighbor cells according to an embodiment of the present principles.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

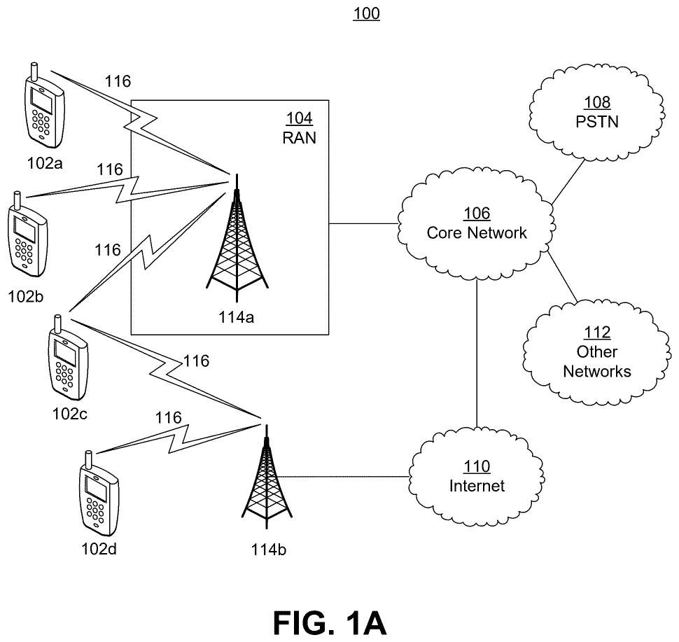

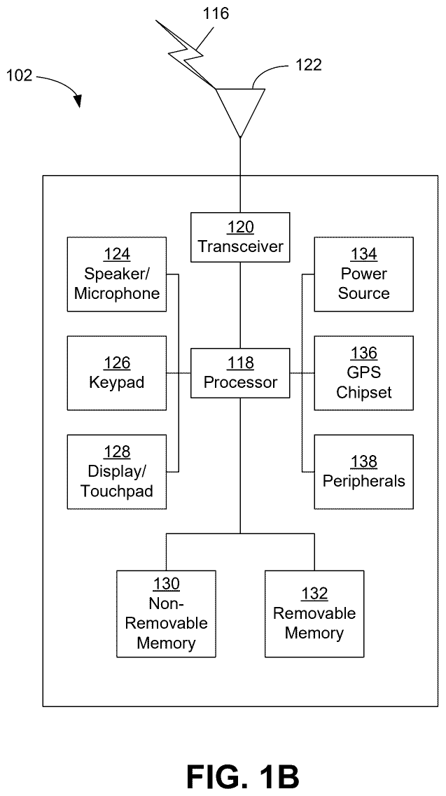

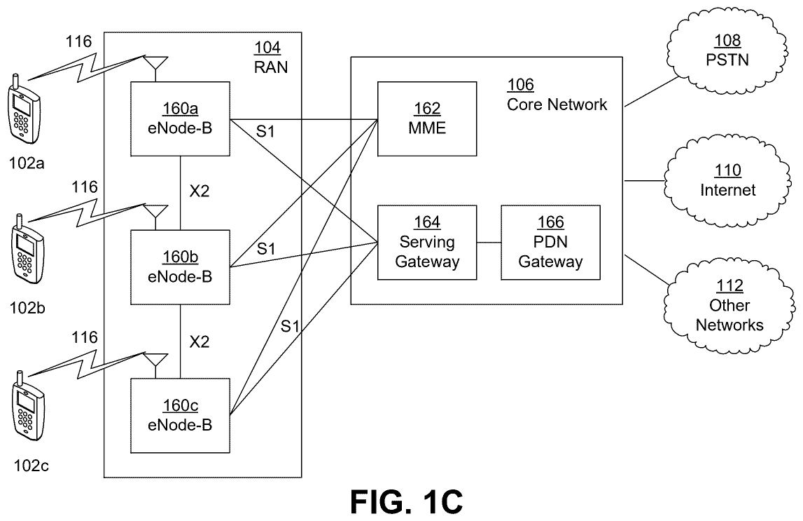

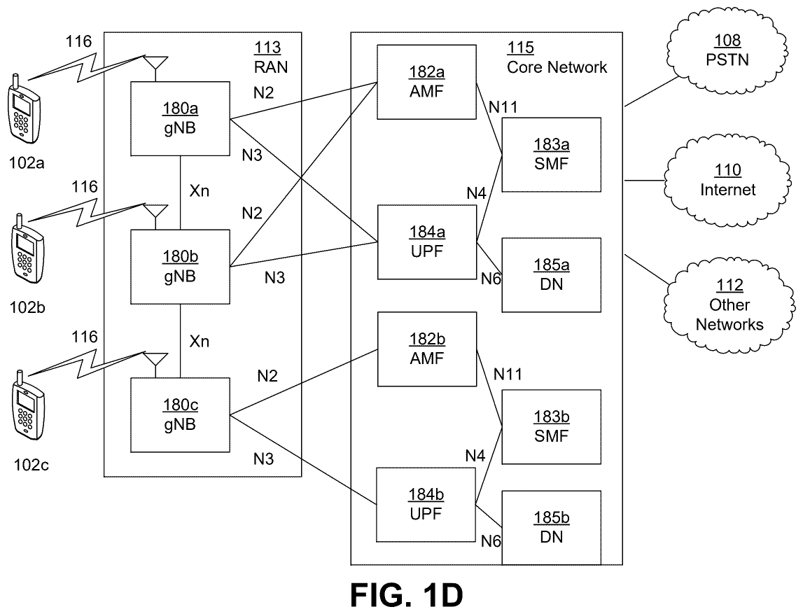

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire (i.e. obtain) location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

3GPP introduced lower-layer triggered mobility (LTM) in Rel-18 and agreed to a work item for enhancement in Rel-19 [see RP-234036, New WID: NR mobility enhancements Phase 4]. 3GPP TS 38.300 v18.1.0 section 9.2.3.5, including FIG. 9.2.3.5.2-1, describes LTM in detail.

It is expected that 6G mobility will use LTM procedures introduced to NR as a baseline.

Several companies have expressed an interest in improved operation amongst distributed/multiple Transmission and Reception Points (TRPs) in 6G.

For example, according to “6G RAN-key building blocks for new 6G radio access networks”, Ericsson, 15 May 2024: “Distributed MIMO where the antenna elements are spread out (in academic literature this is often, somewhat incorrectly, referred to as “cell-free MIMO”). This is primarily of interest for denser deployments. By exploiting transmissions from multiple radio sites, a high degree of reliability can be achieved along with high data rates and interruption-free mobility.

Scheduling strategies can also be refined. Ideally, the transmission points and frequency resources in an area should be seen as a single, unified resource over which the scheduler operates with the target of always assigning the best combination of frequencies and transmission points to the transmissions. Although this to a large extent is an implementation aspect, the signaling mechanisms defined for 6G should be designed with this in mind. Avoiding synchronous timing dependencies between the user equipment (UE) and network and a reduction in scheduling constraints are prerequisites for such implementations.

Having one scheduler handling multiple transmission points and carriers also enables various forms of coordination and can better take the interference situation into account. Efficient interference coordination, enabled by a more centralized type of scheduling when feasible, is one of the more promising ways to improve performance on a given site grid. AI/ML is also an interesting tool to investigate in this area.”

And, according to R1-167205 “UE-cell-center-like Design Principles and Tracking Signal Design”, Huawei: “Targeting to support seamless mobility, as a UE moves among the TRPs within a hypercell, there is no L3 mobility (i.e., handover or cell selection/reselection) and no mobility interruption, which is key performance requirements in NR; while as the UE moves across different hypercells, these TRPs that belong to different hypercells can facilitate ”make before break“ mechanism to minimize mobility interruptions. The group of TRPs (e.g. multiple macros and picos) operate together and look like one to the UE, i.e., the actual TRPs belonging to a hypercell are transparent to the UEs. On the other hand, network can configure a subset of TRPs within the hypercell to transmit synchronization signals and essential system information. The hypercell ID is used for synchronization purposes and entry to NR system, which impacts synchronization signals and the channel design of carrying essential system information. While the system design needs to study the UE operations with minimized dependencies to hypercell ID, in order to eliminate the cell limitation.”

### 6G Mobility and Reference Signals

Mobility in NR has evolved over several releases of the 3GPP specification, starting with L3-based handover for mobility, and lower-layer beam management solutions. Conditional handover (CHO) and LTM were added later. In 6G it is expected that these mechanisms will be unified, with a single solution used for both lower-layer mobility/beam handling as well as “traditional” higher-layer mobility. It is likely that such a mechanism will be largely based on LTM as defined in 3GPP Releases 18 and 19.

In addition, if a carrier or transmission point is not needed for data transmission in the network, it should be possible to put it to sleep and then rapidly wake it up when needed. In NR, all transmissions depend on the synchronization signal block (SSB). Rapidly turning off a 5G node is therefore problematic as it also affects idle-mode UEs relying on SSBs being present continuously. If 6G is designed with separate signals for idle and connected mode, a node used only for data transmission would not need always to transmit idle mode SSBs and the node could be turned off without impacting idle mode UEs, which can enable separate optimization of idle and connected mode functionality, in terms of both energy saving and mobility and scheduling requirements.

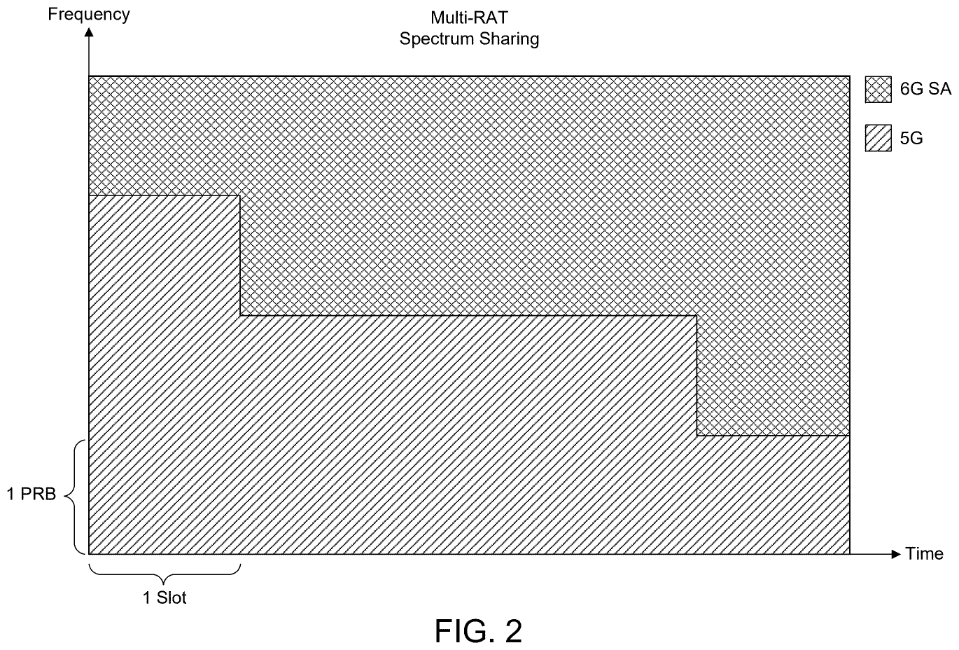

In addition, discussion around 6G migration (e.g. in Migration Next Steps, Ericsson, 6GIG#3, Stockholm, Jun. 25-27, 2024, and in Migration Next Steps, NTT DoCoMo, 6GIG#3, Stockholm, Jun. 25-27, 2024) suggests that multi-RAT spectrum sharing (MRSS) will be necessary in order to allow operators to use existing spectrum to deploy 6G, and gradually migrate the spectrum from 5G to 6G, as illustrated in FIG. 2, taken from the former.

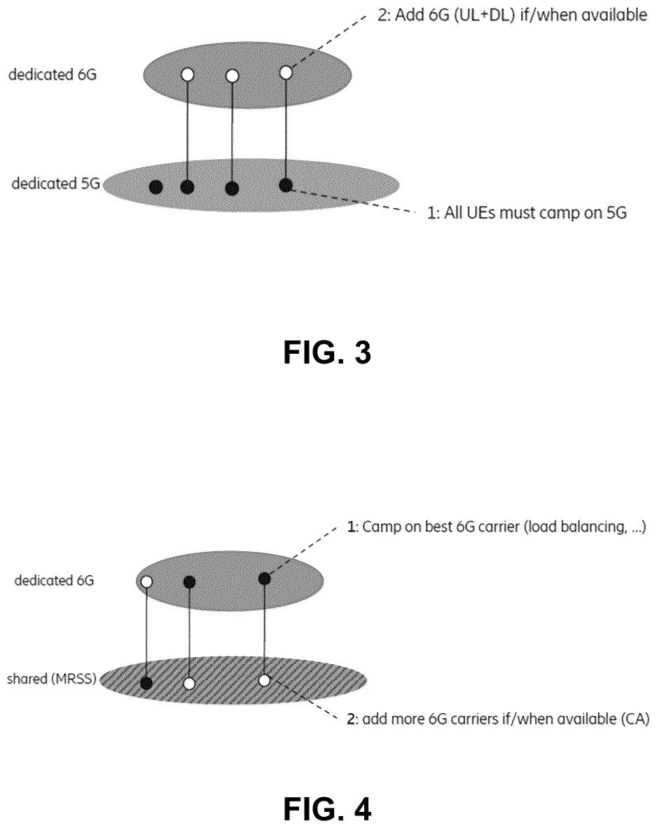

One option being considered is a dual connectivity solution, similar to that of EN-DC (UE connected to LTE as a primary cell group, and NR as a secondary cell group), as illustrated in FIG. 3, ibidem. With this approach, UEs camp and connect on 5G carriers, which leads to lower data rates due to narrower carriers and higher load (higher load, because 5G and 6G UEs will be camped and connected in 5G). Additional 6G spectrum can be added only after connection setup, and used with a slow aggregation scheme (DC) which may benefit only large file transfers.

Another option being considered is deployment of 6G only as a standalone system, with MRSS for already deployed 5G bands, as illustrated in FIG. 4, ibidem. With this approach, load balancing can ensure that UEs camp and connect on the best carrier, for example on a wide cm-band carrier if in coverage. This would allow to setup high data rates instantaneously, where 6G users would benefit from low load on 6G carriers and with more optimal distribution of traffic across spectrum assets. Downlink carrier aggregation (CA) enables dynamic utilization of all carriers.

In 6G, it is expected that there are several scenarios in which reference signals used for mobility measurements are unpredictable and not always known to the UE. For example, if certain beams or cells are switched off for energy saving purposes, or if the spectrum is dynamically changed in terms of 5G or 6G allocation, then the presence and the location of reference signals such as SSB or Channel State Information Reference Signal (CSI-RS), which are typically measured when preparing to perform a cell/beam handover or addition, may be unknown.

In addition, it is expected that during 6G migration, when MRSS is enabled for spectrum sharing on certain carriers between 6G and 5G NR/4G LTE, and standalone 6G carriers are deployed, then the standalone 6G carriers are expected to be prioritized in terms of provision of service for devices supporting 6G. In this case, the typical approach of enabling the UE to perform measurements for connected-mode mobility only when the serving cell or carrier signal quality deteriorates may not be suitable. This mechanism is intended to allow UE to save power by not performing measurements (e.g. on intra-frequency, inter-frequency, or inter-RAT neighbor cells) all of the time. Only when the coverage of the serving cell deteriorates (e.g. below a threshold) the UE is required to perform measurements of neighboring cells to ensure that a suitable neighbor can be used for handover when required for coverage reasons.

The scenario of prioritizing handover to a neighbor cell based on service or load, rather than for coverage reasons, presents different requirements for when the UE should perform measurements, because the serving cell quality may be suitable. For this case, it may be advantageous for the UE to be able to save power, while still allowing 6G standalone carriers to be measured and prepared for handover which is not necessarily based on serving cell measurements.

It will thus be appreciated that there is a need for a solution that can enable a UE to detect and measure neighbor cell reference signals, which are not always present, and to prioritize handover to certain carriers, while limiting the power consumption due to frequent measurements.

The present principles provide triggering of aperiodic Radio Resource Management (RRM) measurement of LTM neighbour cells in which, briefly speaking, a UE is configured, along with candidate configurations, with multiple resource configurations (e.g. location, etc.) for LTM candidates, an indication that one or more of these are not always present (i.e. aperiodic—the terms “not always present RS” and “aperiodic RS” are interchangeably used throughout this disclosure), and a first and second measurement based condition, the UE performs the measurement according to the first measurement based condition (not including the not always present RSs), the UE receives notification indicating presence of one or more of the resource configurations, the UE performs the measurement according to the second measurement based condition (including the not always present RSs), and, according to the condition, the UE transmits a measurement report to the source or performs reconfiguration to the target.

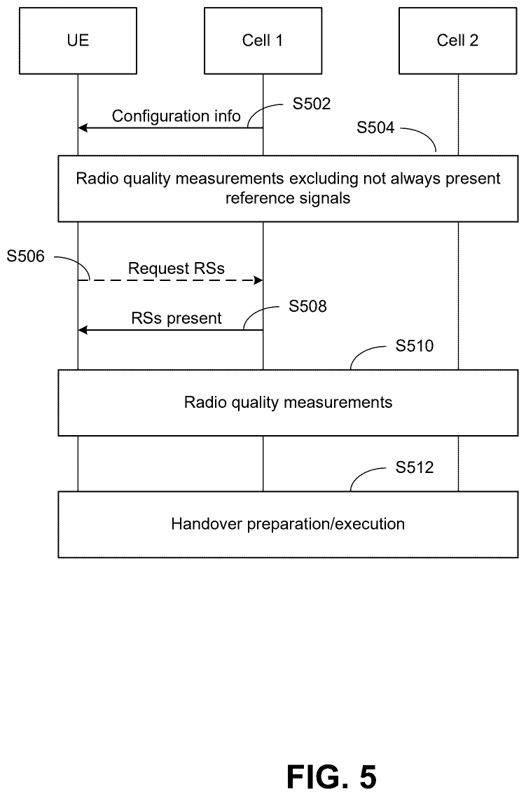

FIG. 5 illustrates, in more detail, a method for triggering of aperiodic RRM measurement of LTM neighbor cells according to an embodiment of the present principles.

In step S502, the UE receives information indicative of one or more handover configurations for one or more candidate cells (e.g. like LTM). The UE typically stores the information that can include one or more measurement Resource Signal (RS; e.g. SSB or CSI-RS) and an indication that one or more of these measurement RS is not always present. The information can further include first measurement quality evaluation criteria for use when the not always present RS is/are not present, and second measurement quality evaluation criteria for use when the not always present RS is/are present.

In step S504, the UE performs RRM measurement of the RSs, excluding the not always present RSs; i.e. the UE performs measurements on the periodic RSs. The UE further evaluates the measurements using the first measurement quality evaluation criteria. It will be appreciated that this is similar to conventional mobility measurements but excluding the not always present RSs.

In step S506, based on the evaluation of the measurements excluding not always present RSs, the UE can transmit a request for timing information/transmission of the not always present RSs. In embodiments, for example in case it is not the UE that causes the not always present RSs to be present, this step can be omitted.

In step S508, the UE receives an indication that not always present RSs are present. The indication can for example be an explicit indication from the source/serving cell, e.g. media access control control element (MAC CE), DCI, etc. The indication can also be a signal contained in an always on and always measured signal of the neighbor cell; for example, the UE performs measurement of idle mode RSs and when the indication is present, the UE also measures connected mode RSs.

In step S510, the UE performs RRM measurement, including not always present RSs and evaluates the measurements using the second measurement quality evaluation criteria.

In step S512, based on the evaluation of the measurements including not always present RSs (i.e. based on the measurements and the second measurement quality evaluation criteria), the UE can prepare handover (e.g. send a report, for example to the source cell, the report including the first and/or second measurement results (depending on criteria)) and/or execute handover (e.g. execute a first or a second reconfiguration (based on whether first and/or second criteria is met)).

This method can enable measurement of aperiodic reference signals to allow mobility towards higher priority carriers in connected mode, while allowing power saving at UE.

### Perform Mobility Procedure

Herein, the terms “perform mobility procedure” and “perform mobility” refer to performing any/all of the steps described in 3GPP TS 38.300v18.1.0 , FIG. 9.2.3.5.2-1 for NR, and to similar procedures for 6G. Specifically, early synchronization in DL and/or UL to one or more of the candidate cells, performing L1 measurements and reporting on one or more of the candidate cells, switching (i.e. performing handover) between candidate cells (“Perform LTM” can mean that the UE moves/switches between multiple candidate cells during the procedure). This may also be used to refer to the process of adding a cell (e.g. a second cell) to the UE connection configuration (e.g. instead of switching from one cell to another, adding a second cell in addition to the first) or may be used to refer to releasing a cell (e.g. once the UE has more than one cells configured, releasing one or more of those cells)

### Candidate Cell Sets

The one or more candidate cell sets may be groups of more than one RRC configuration corresponding to a handover configuration for one or more candidate SpCells and optionally SCells. This may be modelled or received as one or more complete RRC Reconfiguration messages, one or more cell group configurations, or one or more cell configurations. Each of the candidate cell configurations may include a candidate configuration identifier, and each of the candidate cell groups may include a candidate cell group identifier. If the grouping is performed at RRC, the switching between different sets of candidate cells may include updating the serving cell indexes or candidate configuration indexes which are used in L1 and MAC signaling to refer to specific indices (for example a MAC CE triggering the reconfiguration may include a candidate configuration index informing the UE which cell to perform the reconfiguration to).

The one or more candidate cell groups may be configured as a single list or group of candidate cell configurations at RRC. The grouping may occur at the early sync or LTM execution phase rather than at the configuration phase - what this means is that the candidate cell set may be considered as a single group in terms of an RRC configuration list or group, while the cells selected for performing early sync, L1 measurements, and LTM execution depend on a further grouping into multiple subsets of the overall candidate cell list. In other words, the grouping itself may not be modelled at RRC using candidate configuration identifiers, but the grouping is executed as part of the early sync or the LTM execution procedure.

Herein, the term LTM candidate configuration may apply to any type of preconfigured cell information. For example, a UE may be configured with one or more conditional reconfigurations such as conditional handover (CHO), conditional PSCell addition (CPA) or conditional PSCell change (CPC) which are valid before and/or after a cell change or cell addition or cell release, or valid in certain cells.

### SSB

Synchronization Signal Block or SS/PBCH block, which may include at least one of the following: Primary Synchronization Signal (PSS), Secondary Synchronization Signal (SSS), Physical Broadcast Channel (PBCH) (Data, Master Information Block (MIB)) and PBCH (Demodulation Reference Signal (DM-RS)). The SSBs may be transmitted by a network node (e.g. base station, TRP, relay node, Reconfigurable Intelligent Surfaces (RIS) unit) in different directions as beams. The number of SSB beams in an SSB burst set, which may be transmitted periodically within an interval (e.g. 5 ms) may depend on the carrier frequency. For example, an SSB burst may contain 4 SSBs for FR1 (<3 GHz), 8 SSBs for FR1 (3 to 6 GHz) and 64 SSBs for FR2. Certain SSBs may be transmitted as on-demand SSBs (OD-SSBs), which may possibly include a subset of SSBs in a burst. Such OD-SSBs may be transmitted aperiodically, semi-persistently, or periodically with certain periodicity. The transmission of such OD-SSBs may be triggered by the network node or the UE (e.g. via transmission of an UL Wake-up signal (WUS)). Some SSBs may include slim/lean SSBs, which may include PSS only, PSS and SSS-only, PBCH or a subset of MIB-only, for example.

### CSI-RS

Channel State Information Reference Signal, which may include one or more of CSI-RS resource set ID, CSI-RS resource ID/index, resource mapping, power control offset values (e.g. with respect to PDSCH, SSB), scrambling ID, periodicity, offset and Quasi Co-Location (QCL) info. CSI-RS may be transmitted in DL by a network node as CSI-RS beams, via different resource types including periodic, semi-persistent and aperiodic.

### CSI

Channel State Information, which may include one or more of channel quality index (CQI), rank indicator (RI), precoding matrix index (PMI), a L1 channel measurement (e.g. Reference Signal Received Power (RSRP) such as L1-RSRP, or SINR), CSI-RS resource indicator (CRI), SS/PBCH block resource indicator (SSBRI), layer indicator (LI) and/or any other measurement quantity measured by the UE from the configured CSI-RS or SS/PBCH (SSB) block.

### Channel Conditions

The term channel conditions can refer any conditions relating to the state of the radio/channel, which may be determined by the UE from one or more of a UE measurement (e.g., L1/SINR/RSRP, CQI/MCS, channel occupancy, RSSI, power headroom, exposure headroom), L3/mobility-based measurements (e.g. Reference Signal Received Power (RSRP), Reference Signal Received Quality (RSRQ), s-measure), a RLM state, and/or channel availability in unlicensed spectrum (e.g. whether the channel is occupied based on determination of a Listen Before Talk (LBT) procedure or whether the channel is deemed to have experienced a consistent LBT failure).

### L1 Measurement

A L1 measurement herein may include measurement of RSRP, RSRP, RSSI, etc., performed by a UE of a cell, a beam, a set of cells, or a set of beams. Such a L1 measurement may be similar to L3 measurements reported in RRM, with differences in the filtering, reference signals measured, reporting mechanisms, etc. Herein, measurements generally refer to L1 measurements for LTM. However, certain embodiments may apply also to RRM/L3 measurements, as well as other measurements (e.g., measurements of speed, location, height, traffic, etc.).

Herein, the LTM cell switch generally refers to L1/2 triggered mobility whereby a preconfigured RRC configuration is applied when the UE receives an indication using MAC CE or when a certain condition is met at the UE. However, certain embodiments also apply to an RRC reconfiguration, an RRC conditional reconfiguration, as well as other types of mobility procedure.

### Radio Access Technology (RAT) Applicability

Herein, the terms, channels, and protocol design for 5G NR are used, but it should be understood that the described solutions apply equally to other cellular networks such as a 6G 3GPP system, which may use different definitions for channels, signals, and so on. In the context of a 6G or other future generation wireless network, some functions may or may not be necessary, depending on the system architecture, protocol design, and physical channel design; however it is assumed that a system operates using the general principle that configurations are provided by an upper (e.g. RRC) layer which apply to multiple target cells, beam, or TRPs and the lower layer (e.g. MAC, L1) controls switching between the configurations.

The embodiments herein are described in terms of RAT mobility between cells in 5G NR and/or a new radio access technology to be defined for 6G communications. Throughout the disclosure the term “6G NR” is used to refer to the latter RAT, however as the naming is yet to be defined this may be used interchangeably with any other term used to describe the 6G radio access technology. Although the embodiments refer to interworking within or between 5G NR and 6G NR, the solutions may similarly be applied to mobility between or within any RATs whereby at least one of the RATs uses an LTM or similar mobility procedure, for example LTE and 6G NR, LTE and 5G NR, and so on.

The intention of the described embodiments is to enable devices to perform mobility between different radio access technologies (RATs) or different cells in the same RAT, for example between standalone 6G carriers and 5G and/or 6G MRSS carriers. Where candidate cells, target cells, measurements, and so on, are described, this may refer to any beam, cell, physical resource, measurement, or procedure, on a RAT. For example, to “perform LTM”, may mean to “perform LTM from 5G to 6G” or it may mean to perform LTM from a 6G cell to another 6G cell.

### LTM Configuration

The gNB (e.g. a CU in case of Centralized unit/distributed unit (CU/DU) split architecture-note: RRC resides in CU) configures potential LTM candidates using RRC signaling. In one embodiment, the UE receives the LTM candidate configurations in RRC Reconfiguration messages, for example during the “LTM preparation” phase shown in 3GPP TS 38.300v18.1.0, FIG. 9.2.3.5.2-1. The UE may store the LTM candidate configurations to apply later upon receiving an indication using L1/2 signaling (e.g. MAC CE) to perform a cell switch, for example in the “LTM execution” phase shown in the same figure.

In an embodiment, the configuration of potential LTM candidates may include candidate sets; for example, a first set that may be suitable for a first path (for example, a UE turns left and takes first road) and a second set that may be suitable for a second path (e.g. UE turns right and takes second road).

In an embodiment, some or all of the candidate set information is broadcast in system information, and the UE enables the pre-configuration of this broadcast configuration information upon receiving an indication in dedicated signaling (e.g. RRC Reconfiguration) that refers to the broadcast one or more configurations (e.g. using an index or identifier).

In an embodiment, the configuration may include all or a subset of the potential cells in a specific area (for example all cells belonging to the CU with which the UE is currently connected or cells within a particular geographical area). These cells may not yet have been detected or measured by the UE but are configured in advance. In an embodiment, after the initial configuration of LTM candidate configurations, the UE may receive information indicating an update to the configuration to modify, add, remove, or replace any part of the LTM candidate configurations.

In an embodiment, the UE may receive an indication to enable or disable some or all of the LTM configurations. For example, if it is predicted that the UE mobility would be better handled using L3 (e.g. RRC measurement report, RRC reconfiguration, conditional reconfiguration), then LTM may be disabled, and if it on the other hand is predicted that LTM would better suit the UE mobility, then LTM may be enabled (e.g. a previously configured and disabled LTM configuration may be re-enabled).

The configuration may in an embodiment be based on a prediction model internal to, and determined by, the network (e.g. gNB). This prediction may, for example, be based on what the network prediction model determines to be the UEs most likely paths.

In an embodiment, the candidate cell configurations contain all or part of the information necessary to complete a reconfiguration (e.g. handover) to the candidate cell, such as channel configurations (e.g. Physical Random-Access Channel (PRACH), Downlink Physical Control Channel (DPCCH), Downlink Physical Shared Channel (DPSCH)), CORESET, Bandwidth Part (BWP), security parameters, L2 parameters (e.g. Medium Access Control (MAC), Radio Link Control (RLC), Packet Data Convergence Protocol (PDCP)), radio bearer configurations, and so on.

### Configuration of Measurement RSs

The UE may receive, as part of or separately from the LTM candidate configuration information, information indicative of one or more measurement RS configurations. (e.g. like SSB or CSI-RS), one or more CSI report configurations, one or more L1 or L3 measurement event configurations, and/or one or more conditional reconfiguration configurations.

The measurement RSs may be SSB, CSI-RS, or similar measurement resource types. One or more of these measurement RS may be indicated as not always present.

The measurement RSs may include multiple resource pattern(s) for MRSS (e.g. resource grid formats, variations on FIG. 2). For example, in case some resources at times are 6G signals, while they at other times are 5G RSs/signals.

In case a dynamic TDD pattern is configured, the measurement RSs may be present only in some subframes or frames.

In case separate RSs are defined for idle mode and connected mode, then some signals may be always present, and other signals may only be present when necessary. For example, SSB-like resources may be always present to allow for UEs always to measure and discover a cell for the purpose of idle mode or connected mode mobility, while CSI-RS-like resources may be transmitted only when necessary (e.g. when a UE needs to be scheduled with dedicated resources) and may be absent (e.g. switched off) at other times to conserve network power and resources. Such configurations may use one of a set of different resource patterns, they may for example have less frequently transmitted RSs or more densely transmitted resource RS.

The one or more resource set patterns may be associated with an identifier or index, which can be referred to in a subsequent signaling message (e.g. so that a MAC CE can be used to activate different resource patterns).

The RS resources may be aperiodic, semipersistent or periodic.

The RS resources may include one or more of a frequency and/or time location (for example a start PRB or PRB index, a number of PRBs, an RB pointer, or a slot location, length), subcarrier spacing, code domain configuration, slot configuration, bandwidth, cell identity, beam identity, and RAT identity.

Multiple RS types may be configured. The multiple RS types may be associated with each other. For example, multiple CSI-RS resources may be associated with one or more SSBs, or alternatively an idle mode RS type (e.g. always present, wider beam) may be associated with one or more connected mode RS types (e.g. not always present, narrower beam).

### Measurement Quality Evaluation Criteria

The UE may receive information indicative of a configuration including first measurement quality evaluation criteria for use when the not always present RS are not present, and second measurement quality evaluation criteria for use when the not always present RS are present. Some non-limitative examples of quality evaluation criteria will now be given.

In a first example, when evaluating a conditional LTM, more or less weight may be assigned when the measurement includes not always present RSs. An offset or factor may be used for increasing the cell quality determination used for determining the cell switch trigger when always present RS are present.

In a second example, S-measure is not used when not always present RSs are present, and applied when these are not present, which may cause the UE to measure a cell regardless of serving cell quality, when the not always present RSs are present. S-measure is a threshold for the serving cell quality, which allows the UE not to measure neighbor cells when the serving cell quality is above the S-measure threshold.

In a third example, when evaluating a conditional LTM, the UE may use different evaluation/trigger conditions (e.g. number of beams, threshold, time to trigger, hysteresis, and so on).

In a fourth example, measurement reporting criteria may be different (e.g. report using a higher or a lower threshold, or include more beam results when not always present RSs are present).

In a fifth example, the rate of measurements may be faster/slower (e.g. measure more frequently when not always present RSs are present).

In a sixth example, different measurement gap patterns are be applied to enable the UE to spend more time measuring when not always present RSs are present.

Measurement quality evaluation criteria can be any one of the “execution triggers” that will be further described.

### Execution trigger

The term execution trigger herein refers to a condition for performing LTM (e.g. a conditional handover trigger or measurement report trigger) or for adding or releasing a source or target cell to the connection, which is either configured or indicated by the network to the UE, or estimated or determined by the UE. Information indicative of a trigger may be received to change the PDCCH which the UE monitors for scheduling from a first cell to a second cell, or the trigger may add a PDCCH from a second cell (so that the UE monitors more than one PDCCH). The trigger may indicate a L1 change only, and a separate trigger may be used to change the upper layer configuration. For example, the UE may receive a PDCCH from a first cell indicating data (e.g. PDSCH) resources on a second cell. Following this, the UE may receive an indication (e.g. PDCCH or MAC CE) to start monitoring PDCCH on a second cell. At this point the UE may or may not apply an upper layer configuration for the second cell (so, for example, the first cell may continue to handle upper layer protocols such as MAC, RLC, PDCP, RRC while the second cell performs scheduling at Layer 1).

A trigger may be based on one or more of time (e.g. absolute or relative time measured time at UE, System Frame Number (SFN), subframe number, difference in timing between a source and a target cell), radio quality measurement or predicted radio quality one or more of the serving cells or target cells (e.g. RSRP (beam or cell), RSRQ (beam or cell), cri-RI-PMI-CQI, cri-RI-i1, cri-RI-i1-CQI, cri-RI-CQI, cri-RSRP, ssb-Index-RSRP, and cri-RI-LI-PMI-CQI), position (e.g. an area (e.g. defined by reference point and radius) or range of co-ordinates, or a distance threshold from a reference location), a L3 measurement event (for example, Event A1 (Serving becomes better than threshold), Event A2 (Serving becomes worse than threshold), Event A3 (Neighbor becomes offset better than SpCell), Event A4 (Neighbor becomes better than threshold), Event A5 (SpCell becomes worse than threshold1 and neighbor becomes better than threshold2), Event A6 (Neighbour becomes offset better than SCell), Event B1 (Inter RAT neighbour becomes better than threshold), and Event B2 (PCell becomes worse than threshold1 and inter RAT neighbor becomes better than threshold2), a L1 measurement event or condition (for example a defined event that utilizes L1 beam measurements to evaluate whether a criteria or condition is met, such as Event LTM1 (Beam of serving cell becomes better than absolute threshold), Event LTM2 (Beam of serving cell becomes worse than absolute threshold), Event LTM3 (Beam of candidate cell becomes amount of offset better than beam of serving cell), Event LTM4 (Beam of candidate cell becomes better than absolute threshold), and Event LTM5 (Beam of serving cell becomes worse than absolute threshold1 AND Beam of candidate cell becomes better than another absolute threshold2), a time or location based condition (for example, time measured at UE is within a duration from threshold, distance between UE and referenceLocation1 is above threshold1 and distance between UE and referenceLocation2 is below threshold2, and distance between UE and the serving cell moving reference location is above threshold1 and distance between UE and a moving reference location is below threshold2), a combination of L3, L1, time, location-based conditions or events (for example, time measured at UE is within a duration from threshold AND beam of candidate cell becomes better than absolute threshold, distance between UE and referenceLocation1 is above threshold1 and distance between UE and referenceLocation2 is below threshold2 AND beam of candidate cell becomes amount of offset better than beam of serving cell, and distance between UE and the serving cell moving reference location is above threshold1 and distance between UE and a moving reference location is below threshold2 AND beam of serving cell becomes worse than absolute threshold1 AND beam of candidate cell becomes better than another absolute threshold2), a predicted event (for example a prediction of event A5), explicit indication from the network (for example, the UE may enable CSI reporting based on an explicit indication (e.g. a MAC CE) received from the network, and then execute LTM cell switch upon receiving a second MAC CE from the network), a measured, predicted, or estimated throughput, error rate, buffer status, data amount, or QoS parameter, and an evaluation metric (for example a time-to-trigger, a hysteresis, offset (e.g. a radio quality measurement offset), and a measurement filtering configuration).

The trigger may include one or more conditions under which the UE is allowed to perform any action related to LTM. For example, the UE may perform one or more of the following procedures: Early TA acquisition (the UE may trigger a RACH to a target LTM cell, where the UE may receive a TA value in a RAR (e.g. that may come from a target cell, or via a source cell), UE may receive a TA value in a MAC CE triggering the cell switch, or the UE may perform power ramping and preamble retransmission on the target if a RAR/MAC CE is not received; the UE may acquire the TA value of a candidate LTM cell by measurement, and trigger when complete, wherein the UE may support and be configured with UE-based TA measurement, whereby the UE acquires the TA value(s) of the candidate cell(s) by measurement), Switching off CSI reporting (the UE may be allowed to, or required to, switch off CSI reporting in order to reduce reporting overhead in the uplink; the CSI reporting may be reduced rather than switched off (for example, reduced number of cells or beams reporting, or a reduced frequency of reporting); the UE may resume CSI reporting when the condition is no longer met), Switching on or updating the CSI reporting configuration (for example, the UE may be required to perform and report CSI measurements on one or a subset of LTM candidate cells during the window), Performing LTM cell switch (based on conditions or criteria under which the UE is allowed to trigger LTM cell switch), Monitoring PDCCH on a target cell (the UE may be configured to monitor on a target cell for a DCI scheduling PDSCH or indicating one or more actions on the target cell, for example to initiate the cell switch procedure), Performing BFR or RLM on a target cell (the UE may be configured to monitor BFD (beam failure detection) resources on a target cell, or perform RLM (radio link monitoring) on a target cell during the window), Activating or deactivating certain SCells (the UE may be configured with one or more specific SCells which should be active or not active during the window), Adding or releasing certain PCells (for example, the UE may connect to a new PCell before releasing the present PCell), and Adding or releasing certain physical layer configurations (for example, the UE may connect to a physical channel configuration associated with a new Cell while maintaining a physical channel configuration associated with the current cell without changing the upper layer configuration associated with the current cell; in other words, the UE may be configured with a new physical channel which is provided by a second cell, but as part of the current cell configuration and without changing the configuration to the new cell configuration).

### Perform and Evaluate RRM Measurement

### Evaluation of Measurements That Exclude Not Always Present RSs

The UE may be configured with different evaluation metrics or conditions depending on whether certain RSs are present or not at the time of performing the measurements. For example, the UE may evaluate measurements using the first measurement quality evaluation criteria (e.g. similar to normal mobility measurements but excluding the subset of not always present RSs). For example, when serving cell measurement is below S-measure, perform neighbor measurements, evaluate reporting/conditional handover triggers, etc., use a first rate of measurements (for example, less frequent than when the RSs are present), use a first cell quality derivation (for example, using less beams or less weight to measurement samples), use a first conditional reconfiguration criteria (e.g. perform reconfiguration if target cell above a threshold and source cell below a threshold (event A5/LTM5)), use a first reporting criteria or reporting configuration (e.g. a relatively higher threshold, or CSI report config and resources), and use first measurement gap pattern (e.g. less frequent or shorter gaps).

### Evaluation of Measurements That Include Not Always Present RSs

The UE may evaluate measurements using the second measurement quality evaluation criteria when the not always present RSs are known to be present. For example, regardless of S-measure, perform neighbor measurements, evaluate reporting/conditional handover triggers, etc., use a second rate of measurements (e.g. more frequent), use a second cell quality derivation (e.g. higher weighting due to additional RSs), use a second conditional reconfiguration criteria (e.g. perform conditional reconfiguration using only the target cell quality is above a threshold (event A4/LTM4)), use a second reporting criteria (e.g. relatively lower threshold, or different CSI report config and resources), and use second measurement gap pattern (e.g. longer gaps to perform more measurements).

Based on the evaluation criteria and the RRM measurement, including not always present RSs, the UE may be configured to, if the measurement criteria for conditional LTM is met, execute the reconfiguration towards the target cell, or else if the reporting criteria is met, transmit measurements to the source cell. The UE may also evaluate using the first and second measurement quality evaluation criteria and, based on whether one or both are met, perform one or more actions. A first action is to send a report to the source cell, the report including first and/or second results (depending on criteria), a second action is to execute a first or a second reconfiguration (based on whether first and/or second criteria is met), and a third action is to enable a third evaluation.

This will now be further explained with some examples, assuming that the UE makes first measurements without the not always present RSs (measurement 1), and then possibly some second measurements with the not always present RSs (measurement 2).

In case measurement 1 satisfies the first criteria, then measurement 2 can be performed. In case measurement 2 meets the second, criteria, then the UE could perform the reconfiguration (i.e. the measurement using these aperiodic RSs shows that the target cell is good enough for handover). However, in case measurement 2 does not meet the second criteria (i.e. target cell not good enough), then the UE sends a report to the source cell instead.

An alternative is that, based on the results of measurement 2, the UE performs one of two possible reconfigurations (that for example can involve activation of different SCells).

As for the third evaluation, this could mean that if measurement 1 and measurement 2 meet the respective criteria, then the UE performs a beam specific evaluation, for example to select a beam for handover.

### Request for Transmission of Not Always on RSs

The UE may report the measurements of the subset of RS resources using CSI reporting on PUCCH to the source cell and/or the target cell. The report may alternatively be transmitted using a MAC CE or a RRC measurement report, or any other type of uplink signaling. The report may for example include one or more of RSRP (beam or cell), RSRQ (beam or cell), cri-RI-PMI-CQI, cri-RI-i1, cri-RI-i1-CQI, cri-RI-CQI, cri-RSRP, ssb-Index-RSRP, and cri-RI-LI-PMI-CQI.

The UE may be configured to perform and report more than one type of measurement in parallel. For example, the UE may perform measurements of always present RSs (e.g. SSB) and perform measurements of not always present RSs (e.g. CSI-RS). The always present measurements may be used to detect/measure/evaluate cells which may be in a power saving mode, and so not currently transmitting the not always present RSs, while cells which are known to be transmitting the not always present RSs may be measured using those RSs.

Based on the evaluation of measurements excluding not always present RSs, the UE may transmit a report or a request for timing information/transmission of the not always present RSs. The UE may send a report or request to the serving cell, or the UE may send a signal (e.g. reserved preamble, SR, or other signal) to a neighbor which has been determined using the not always present RSs in order that the candidate can activate the connected/not always present RS.

Other conditions may be used for enabling the transmission of the connected mode RS, such as when UE or network detects out-of-sync at physical layer, the UE or the network activates the neighbor connected mode RSs to allow the UE to measure them., and when UE is located at a cell edge (e.g. based on path-loss measurement of the serving cell), the UE requests the neighbor RS transmission (or just informs the network that the UE is at a cell edge) and then the network enables the UE to measure them.

The UE may have multiple measurement configurations for a given cell, for example a state where only the idle mode signals are present (e.g. only SSBs), a state where connected mode signals are infrequent (e.g. CSI-RS is transmitted relatively infrequently), and a state where connected mode signals are frequent (e.g. CSI-RS is transmitted relatively frequently).

In some embodiments, there is an association between the idle mode SSB and the connected mode CSI-RS. Based on a condition associated with the SSB, this event may cause reporting of the resource which may or may not be present to start with. Based on the measured SSB, the beam may be set for CSI_RS, and, based on a report, the network may start to transmit the CSI-RS.

### Indication That Not Always on RSs are Present

The UE may receive an indication that not always present RSs are present. For example, this could be an explicit indication from the source/serving cell, (e.g. MAC CE, DCI, etc.). This may be used in case the neighbor is a higher priority (e.g. standalone 6G) carrier, and measurements are not currently active due to good serving cell quality to force a measurement.

The indication may include an identifier of the cell, RAT, or beam on which the RSs are to be activated.

The indication may include an identifier or index of a particular resource pattern to use. The resource pattern may be preconfigured (e.g. using RRC) and the index may be received in L1 DCI or a MAC CE.

The UE may receive a signal contained in an always on/measured signal of the neighbor cell. For example, the UE performs measurements of idle mode RSs. When an indication is present in the idle mode RSs of a particular cell, the UE determines that the connected mode RSs are present in that cell and the UE additionally or alternatively measures connected mode RSs.

The indication of whether the not always present RSs is present may be received in UE-group common signaling (by DCI).

In some embodiments, this type of signaling can additionally indicate whether a “not always present” RS is present for a subsequent period. For example, the indication may include a number of subframes, frames, millisecond, or other time-based unit, for which the RS will be transmitted.

It some embodiments, the signal may be missed by the UE (for example, unable to decode, or does not have the appropriate measurement gap configurations). However, if transmitted regularly, the UE may still receive this signal.

The indication may indicate an on/off status of resources in one or more neighboring cells, beams, or RATs.

In some embodiments, the indication may be transmitted in multiple ways, for example indicated “within” the SSB may be used by idle mode UEs or UEs performing a general cell search, while UE-group common or dedicated signaling may be used for UEs actively engaged in a mobility procedure (e.g. preparing for an LTM cell switch).

Based on the indication, the UE may then use either the first or second measurement evaluation criteria. The UE may be configured with more measurement conditions (e.g. in case there are more than two types of configurations).

### Cell Switch

A cell switch command may be received in a downlink signal such as DCI, MAC CE. This cell switch command may be received from a source cell (e.g. like NR) or from a target cell (e.g. a cell determined to be the best cell). In some embodiments, for example when a “hyper cell” is used, the cell may be switched without notifying the UE, but rather the network configures, based on uplink measurements, to use a new TRP with the same configuration as the previous one.

In some embodiments, an uplink and a downlink connection may be separately managed. For example, mobility based on reported downlink measurements may be used to manage downlink channels and TRPs, while the network selects uplink channels and TRPs based on uplink measurement signals.

In some embodiments, a cell switch command may be used to add a target cell to the UEs connection configuration or to release a source cell from the UEs connection configuration. That is to say, the UE does not switch from one cell to another, but rather adds a new cell before releasing the previous cell. Different layers of a cell may be added or released at different times, and using different triggers. For example, the physical layer of a cell may be added or released at a separate time than upper layers.

In some embodiments, the cell switch is determined by the UE, for example triggered when certain conditions are met (e.g. a conditional LTM based on L1 or L3 events).

It will be appreciated that the present principles can enable measurement of aperiodic reference signals to allow mobility towards higher priority carriers in connected mode, while allowing power saving at UE.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency trade-offs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method at a wireless transmit/receive unit, WTRU, the method comprising:
performing measurements of at least one first periodic reference signal to obtain first measurement results;
upon reception of information indicative of presence of at least one aperiodic reference signal, performing measurements of at least one second periodic reference signal and the at least one aperiodic reference signal to obtain second measurement results; and
based on the second measurement results and second measurement quality evaluation criteria, performing at least one of preparing for handover or executing handover.

2. The method of claim 1, further comprising:
based on the first measurement results and first measurement quality evaluation criteria, transmitting information indicative of a request for at least one of timing information or transmission of the at least one aperiodic reference signal.

3. The method of claim 2, further comprising:
receiving information indicative of a handover configuration for one or more candidate cells, the information indicative of a handover configuration for one or more candidate cells indicating at least one of the at least one first periodic reference signal or the at least one second periodic reference signal, the at least one aperiodic reference signal, the first measurement quality evaluation criteria and the second measurement quality evaluation criteria.

4. The method of claim 1, wherein the information indicative of presence of at least one aperiodic reference signal is received from a cell currently serving the WTRU.

5. The method of claim 1, wherein the information indicative of presence of at least one aperiodic reference signal is received from a neighboring cell in a periodic signal.

6. The method of claim 1, wherein at least one of the at least one first periodic reference signal or the at least one second periodic reference signal is transmitted in a cell currently serving the WTRU.

7. The method of claim 1, wherein at least one of the at least one first periodic reference signal or the at least one second periodic reference signal is transmitted in a neighboring cell, the neighboring cell being a neighbor to the cell currently serving the WTRU.

8. The method of claim 1, wherein preparing for handover comprises sending, to a cell currently serving the WTRU, information indicative of at least one of the first measurement results or the second measurement results.

9. A wireless transmit/receive unit, WTRU, comprising at least one processor configured to:
perform measurements of at least one first periodic reference signal to obtain first measurement results;
upon reception of information indicative of presence of at least one aperiodic reference signal, perform measurements of at least one second periodic reference signal and the at least one aperiodic reference signal to obtain second measurement results; and
based on the second measurement results and second measurement quality evaluation criteria, perform at least one of preparing for handover or executing handover.

10. The WTRU of claim 9, the at least one processor is further configured to:
based on the first measurement results and first measurement quality evaluation criteria, transmit information indicative of a request for at least one of timing information or transmission of the at least one aperiodic reference signal.

11. The WTRU of claim 10, the at least one processor is further configured to:
receive information indicative of a handover configuration for one or more candidate cells, the information indicative of a handover configuration for one or more candidate cells indicating at least one of the at least one first periodic reference signal or the at least one second periodic reference signal, the at least one aperiodic reference signal, the first measurement quality evaluation criteria and the second measurement quality evaluation criteria.

12. The WTRU of claim 9, wherein the information indicative of presence of at least one aperiodic reference signal is received from a cell currently serving the WTRU.

13. The WTRU of claim 9, wherein the information indicative of presence of at least one aperiodic reference signal is received from a neighboring cell in a periodic signal.

14. The WTRU of claim 9, wherein at least one of the at least one first periodic reference signal or the at least one second periodic reference signal is transmitted in a cell currently serving the WTRU.

15. The WTRU of claim 9, wherein at least one of the at least one first periodic reference signal or the at least one second periodic reference signal is transmitted in a neighboring cell, the neighboring cell being a neighbor to the cell currently serving the WTRU.

16. The WTRU of claim 9, wherein prepare for handover comprises send, to a cell currently serving the WTRU, information indicative of at least one of the first measurement results or the second measurement results.

17. The WTRU of claim 9, wherein execute handover comprises execute, based on whether at least one of the first measurement results meet first measurement quality evaluation criteria or the second measurement quality evaluation criteria are met, a first reconfiguration or a second reconfiguration.

18. The WTRU of claim 17, wherein each of the first reconfiguration and the second reconfiguration include SCells, and wherein the SCells of the first reconfiguration are different from the SCells of the second reconfiguration.

19. The WTRU of claim 17, wherein the first reconfiguration is for a conditional handover.

20. The WTRU of claim 9, wherein at least one of information indicative of the at least one first periodic reference signal, information indicative of the at least one second periodic reference signal, information indicative of the at least one aperiodic reference signal, and the information indicative of presence of the at least one aperiodic reference signal is received by the WTRU in a transmission using media access control control element, MAC CE, with index.
